(19) United States
(12) Patent Application Publication
(10) Pub. No.: US 2021/0117313 A1
(43) Pub. Date: Apr. 22, 2021

(54) LANGUAGE AGNOSTIC AUTOMATION SCRIPTING TOOL

(71) Applicant: MINNIM SOFTWARE, Pittsburgh, PA (US)

(72) Inventor: Allen J. Geary, Pittsburgh, PA (US)

(73) Assignee: MINNIM SOFTWARE, Pittsburgh, PA (US)

(21) Appl. No.: 17/073,002

(22) Filed: Oct. 16, 2020

Related U.S. Application Data
(60) Provisional application No. 62/915,822, filed on Oct. 16, 2019.

(51) Int. Cl. G06F 11/36

(52) U.S. Cl. CPC G06F 11/3684; G06F 11/3688

(57) ABSTRACT

Disclosed herein are systems and methods for framework and language agnostic generation of test-scripts and test-suites. Provided is a platform that enables codeless generation of test-scripts using predefined modular actions and user defined objects and data that may be combined in a test flow. The platform then auto-generates test code (i.e., source code or compiled binary) in a user selected endpoint language, application package, and/or framework (i.e., construct). Should the user later decide to select a different construct, the same test-script may be used to auto-generate new test code in that different user selected construct. The platform also allows users to define the modular actions and create specific implementations of those actions, and define page definitions, device collections, data, functions, and tests. User's may view, use, collaborate, and rate other user defined actions, action implementations, page definitions, device collections, data, functions, and tests in a collaborative environment.

### CROSS REFERENCE TO RELATED APPLICATIONS

The present application claims the benefit under 35 U.S.C. § 119(e) of prior U.S. Provisional Application Ser. No. 62/915,822, filed Oct. 16, 2019, the content of which is incorporated by reference here into this application.

### TECHNICAL FIELD

The present disclosure generally pertains to the field of software testing, and more particularly, to a software application providing language agnostic, automated scripting tools for software quality assurance testing.

### BACKGROUND

Technologies providing automated software quality assurance testing were first envisioned in the 1990s. Such software assisted with Y2K compliance, implantations of enterprise resource planning, and web initiatives. Over the past three decades, however, not much has changed with these automated testing tools. Users still deal with steep learning curves, clumsy integrations with continuous integration tools and loose definitions of agile processes, the requirement to utilize specific coding/scripting languages, and non-scalable scripts that require significant human resources to maintain. Moreover, significant capital expenditures and long-term maintenance contracts were often needed for the prior automated implantations, leading to total dependency on the tool vendor.

Software quality assurance testing is performed to evaluate an attribute or capability of a program or system and determine if it meets the desired result. Although crucial to software quality and widely used by quality assurance engineers, software quality assurance testing remains an art. Moreover, due to the absence of product and operating system agnostic frameworks, such testing can be time-consuming and expensive.

Accordingly, updated cloud-based tools that are easy to use, language-agnostic, and require minimal training are desired.

### SUMMARY

The presently disclosed invention is related to a testing platform providing cloud-based tools that are easy to use, require minimal or no training, and allow a user to define modular actions and combine them into a test flow. This test flow is not reliant on a specific underlying technology and can be exported and executed against any underlying language, application package, and/or endpoint framework. Users can collaborate by creating user defined actions, action implementations, page definitions, device collections, data, functions, tests, generation templates, and integrations.

The testing platform enables automated test-scripting through a user intuitive interface, such as a graphical user interface. The platform comprises an endpoints module that allows the user to define a device and operating system against which a test-script is to be executed, a construct module that allows selection of a construct against which a test-script is to be executed, wherein the construct comprises a language, application package, framework, or combination thereof, an objects module that allows the user to define objects on a system or application under test, an actions definition and implementation module that allows the user to define actions that may be executed against the system or application under test, and a scripting module that allows the user to provide a combination of abstract actions and objects into a test flow to generate a test-script.

The user may arrange/re-arrange the actions and objects in the test flow, including arranging actions and objects in complex tree structures, to define a test-script; may group test-scripts into a test-suite; and may save these abstractions for later use to generate construct specific source code or compiled binary. Moreover, the user may define objects through real-time interaction with the system or application-under-test, such as a web-page, and may test portions of the test-script in real-time during creation of the test-script.

Moreover, a source code or compiled binary for the test-script may be generated in the user selected construct, and the user may reuse the test-script to generate a new source code or compiled binary in a different user selected construct. As such, the system and methods disclosed herein provide an automated scripting tool for software quality assurance testing that vastly improves the ease of test-scripting and renders those scripts language agnostic.

Accordingly, the presently disclosed invention relates to a method for performing a language agnostic, automated quality assurance test. The method generally comprises computer-implemented instructions that, responsive to a request, allow the following steps to be executed: select a construct against which a test-script is to be executed, wherein the construct comprises an endpoint language, endpoint application package, endpoint framework, or combination thereof; select one or more actions and one or more objects to include in a test flow to define the test-script, wherein individual actions and objects may be rearranged in the test flow, and wherein the test-script is construct independent; and generate a source code or compiled binary for the test-script in the selected construct.

According to certain aspects, the method may further comprise, either before generating the source code or compiled binary for the test-script or during selecting the one or more actions and objects to include in the test flow, executing at least one of the selected actions and objects of the test flow in real-time.

According to certain aspects, the method may further comprise, before generating the source code or compiled binary for the test-script, accepting input of attribute values required by the test-script for execution against the selected construct.

According to certain aspects, the method may further comprise, before selecting the one or more actions, accepting a definition of at least one of the one or more actions and a construct specific implementation thereof.

According to certain aspects, the method may further comprise, before selecting the one or more objects, defining at least one of the one or more objects by selection of a web-page object or application object. Selection of the object may occur on a currently rendered web-page, and the method may parse code describing the web-page to identify the object and associate therewith a respective plurality of identification means. Moreover, the plurality of identification means are associated as an object set for storage in an object repository.

According to certain aspects, the method may further comprise, selecting a second construct against which the test-script is to be executed; and generating an alternate source code or compiled binary for the test-script in the alternate construct.

According to certain aspects, the method may further comprise, before generating the source code or compiled binary, validating that construct specific implementations of the actions in the test flow are available.

The presently disclosed invention further provides a system for language agnostic automated test generation. The system generally comprises one or more processors, and memory comprising instructions that when executed by at least one of the one or more processors, perform the above indicated method.

The presently disclosed invention further provides a system for language agnostic automated test generation, the system comprising: one or more processors; and a test scripting automation framework stored in a memory for execution by the one or more processors. The framework generally comprises an endpoints module configured to allow selection of an endpoint, wherein an endpoint is any network connected device capable of executing a system or application under test; a construct module configured to allow selection of a construct against which a test-script is to be executed, wherein the construct comprises a language, application package, framework, or combination thereof, an objects module configured to allow definition of one or more objects on a system or application under test, wherein selection of the object occurs on a currently rendered web-page, and the objects module parses code describing the web-page to identify the object and associate therewith a respective plurality of identification means, an actions definition and implementation module configured to allow definition of actions and construct specific implementations thereof, a scripting module configured to allow generation of the test-script comprising a combination of actions and objects arranged in a test flow, and a generation module configured to generate construct specific software code for the test-script.

According to certain aspects, the framework further comprises a live execution module configured to allow live execution of at least a portion of the test-script to validate functionality of actions, objects, or combinations thereof in the test flow. The live execution module may be further configured to validate an end-point and environment specification.

According to certain aspects, the test scripting automation framework stored in the memory is configured to execute a method comprising the steps: using the construct module, select a construct against which a test-script is to be executed, wherein the construct comprises an endpoint language, endpoint application package, endpoint framework, or combination thereof; using the scripting module, select one or more actions and one or more objects to include in a test flow to define the test-script, wherein individual actions and objects may be rearranged in the test flow, and wherein the test-script is construct independent; and using the generation module, generate a source code or compiled binary for the test-script in the selected construct to provide the automated quality assurance test.

According to certain aspects the test scripting automation framework stored in the memory is configured to execute the method further comprising the steps: using the live execution module during selecting the one or more actions and objects to include in the test flow, execute at least one of the selected actions and objects of the test flow in real-time.

According to certain aspects the test scripting automation framework stored in the memory is configured to execute the method further comprising the steps: using the scripting module, accept input of attribute values required by the test-script for execution against the selected construct.

According to certain aspects the test scripting automation framework stored in the memory is configured to execute the method further comprising the steps: using the actions definition and implementation module, accept a definition of at least one of the one or more actions and a construct specific implementation thereof.

According to certain aspects the test scripting automation framework stored in the memory is configured to execute the method further comprising the steps: using the objects module, define at least one of the one or more objects by selection of a web-page object or application object. Selection of the web-page object occurs on a currently rendered web-page, and the computer-implemented instructions parse code describing the web-page to identify the object and associate therewith a respective plurality of identification means, wherein the plurality of identification means are associated as an object set for storage in an object repository.

According to certain aspects the test scripting automation framework stored in the memory is configured to execute the method further comprising the steps: using the construct module, select an alternate construct against which the test-script is to be generated; and using the generation module, generate an alternate source code or compiled binary for the test-script in the alternate construct.

### BRIEF DESCRIPTION OF THE DRAWINGS

A better understanding of the present invention will be had upon reference to the following detailed description when read in conjunction with the accompanying drawings, wherein like numerals represent like features in the various views. It is to be noted that features and components in these drawings, illustrating views of embodiments of the present invention, unless stated to be otherwise, are not necessarily drawn to scale.

FIG. 1 illustrates a block diagram of a system useful for implementation of an automated scripting tool in accordance with certain aspects of the presently disclosed invention.

FIG. 2 illustrates a block diagram of the various components of the automated scripting tool and system in accordance with certain aspects of the presently disclosed invention.

FIG. 3 illustrates a view of a graphical user interface offering selection of an endpoint, wherein the user is selecting Firefox running on an OS device running the Windows operating system in accordance with certain aspects of the presently disclosed invention.

FIG. 4 illustrates a view of a graphical user interface offering selection of a construct, wherein the user may select Java Selenium or Java Appium in accordance with certain aspects of the presently disclosed invention.

FIG. 5 illustrates a view of a graphical user interface showing an exemplary test-script in accordance with certain aspects of the presently disclosed invention.

### DETAILED DESCRIPTION

In the following description, the present invention is set forth in the context of various alternative embodiments and implementations of a language agnostic software testing platform, i.e., a system and method for creating language and framework agnostic test automation test-scripts and test-suites. While the following description discloses numerous exemplary embodiments, the scope of the present disclosure is not limited to the disclosed embodiments, but also encompasses combinations of the disclosed embodiments, as well as modifications to the disclosed embodiments.

Various aspects of the systems and methods disclosed herein may be illustrated by describing components that are coupled, attached, and/or joined together. As used herein, the terms “coupled”, “attached”, and/or “joined” are interchangeably used to indicate either a direct connection between two hardware components, or two software modules, or, where appropriate, an indirect connection to one another through intervening or intermediate components or modules. In contrast, when a component is referred to as being “directly coupled”, “directly attached”, and/or “directly joined” to another component or module, there are no intervening objects shown in said examples.

Various aspects of the systems and methods may be described and illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the word “comprising” as used herein means “including, but not limited to”.

It must also be noted that as used herein and in the appended claims, the singular forms “a”, “an”, and “the” include the plural reference unless the context clearly dictates otherwise. Unless defined otherwise, all technical and scientific terms used herein have the same meanings as commonly understood by one of ordinary skill in the art.

As used herein, the term “platform” shall be taken to mean one or more individual software modules that may combine to perform the functionality of the presently disclosed invention. As used herein, a “test-script” may be understood to mean a set of instructions that are executed on a system or application under test to verify that the system performs as expected. A “test-suite” may then be understood to be a group of test-scripts that together test all or a portion of a system or application under test.

Currently, test-scripts are written in a specific scripting language and are used to automate software quality assurance testing. Such scripts are often closely coupled with the applications or systems under test and thus are not useful to provide generic testing capabilities. A test-script automated on an application may easily break if the dynamic content, such as internal attributes of a page change. Similarly, a test-script automated on an operating system or web browser may break when executed on a different operating system or browser, or even a different browser version due to subtle differences in the browsers' internal representation of a webpage.

Provided herein is a testing platform that provides framework and language agnostic generation of test-scripts and test-suites. The platform offers cloud-based tools and software implemented methods that allow integration with a variety of testing tools while also allowing the user to migrate from one underlying technology stack to another with a simple export. Further, the platform enables codeless creation of these test-scripts through use of predefined modular actions and user defined objects that may be combined in a test flow using a scripting module of the platform. The generation module then auto-generates the test code (i.e., source code or compiled binary) in the user selected endpoint language, application package, and/or framework (i.e., construct). The user may later decide to define a different construct and use the same test-script to auto-generate new test code in the different user selected construct.

The presently disclosed platform allows users to define the modular actions and create specific implementations of those actions in an underlying technology stack. The platform further allows users to define page definitions, device collections, data, functions (i.e., combinations of actions that together perform a specific function), tests, and generation templates. User's may view, use, collaborate, and rate other user defined actions, action implementations, page definitions, device collections, data, functions, tests and generation templates in a collaborative environment.

According to certain aspects, the platform may also provide unique reporting, versioning, and analytics modules, as well as messaging and forum modules that allow additional interaction in the collaborative environment.

The foundation of the presently disclosed invention is simplicity. Key repetitive processes are reduced to small, easily manageable functional units that can be readily and quickly modified, relocated, or replaced. Thus, the presently disclosed invention accelerates the speed of authoring and executing tests, while greatly decreasing the time and effort of ongoing maintenance. With capabilities to recompile and export in formats compatible with tools a user is already using, organizations can easily migrate their testing scripts from one tool to the next with no coding changes. As such, the presently disclosed software testing platform minimizes the stress of future technology changes by providing flexibility that will endure real world conditions over time.

Moreover, according to certain aspects, modules of the presently disclosed testing platform may be provided as cloud-based tools accessible to users via a web interface to perform the different functions of the automated quality assurance testing of a software application.

The testing platform generally includes various modules that are used to define key aspects of a test, such as defining or selecting individual actions, objects, and/or data of a test, combining those selections into a test script, aggregating groups of test-scripts that may be used to test a system or application under test, defining targets on which the system or application under test is to be tested, i.e., environment in which the test-scripts will be run, etc. While the following description is provided by linearly defining the modules, the user may interact with the various modules in any order unless indicated otherwise.

A user may create a new test-script by defining or selecting various actions, objects, data, and a construct against which the test will be performed in a scripting tool. Moreover, according to certain aspects, the actions may be executed individually or partially, i.e., a smaller portion of the test-script, in real time to give the user instant feedback leading to faster test script creation with less trial and error.

Selection of actions to be used in the test-script to provide a test flow would be done in the scripting module using a drag and drop interaction. The user may define the actions used in the test-script, or may use predefined, granular actions such as a “click” or “wait”. The user may define the objects via live interaction with the webpage or software application that is to be tested using a page objects module. The user may also define any data that is to be entered, such as a defined object using a data module. The user may define the languages, and/or frameworks (i.e., constructs) against which the test-script will be run using a constructs module. Should the user later desire to run the test script against a different language and/or framework, they may simply select a different construct in the constructs module and generate the source code or compiled binary in the generation module for that alternately selected construct.

Actions Definition and Implementation Module

As indicated, the user may define abstract granular actions and may link those “actions” to a specific set of events that the defined action may perform. For example, the user may define a “double click” using the keyword creation module and may then link that defined keyword to an underlying implementation that may be executed against a webpage or software application (i.e., an action). Users may select predefined actions from a list of actions, or they may define their own actions. For example, a user may choose to define a functionality not currently available or may customize an existing implementation. As used herein, an implementation comprises the source code of a particular construct needed to fulfill the action.

Every script uses a collection of actions to interact with a system or application under test (i.e., to provide a test flow). Actions are highly versatile and extremely flexible. They can be custom tailored to interact with any range of applications and customized to a user's needs. Users can improve actions over time by updating the implementation (i.e., code) and receiving community input. One of the unique capabilities of the presently disclosed invention is that many of the modules allow the user to create and share various aspects of an action, or test-script, or test-suite. For example, the user may select actions to include in a test flow from a set of predefined actions provided by the community, e.g., actions provided by other users of the platform. The user may also define actions and may choose to share those actions with the community (world permission), with a subset of the community (group permission) or may keep those action private (user permission).

Actions

Actions are descriptive terms with no underlying code. They are the building blocks for building test-scripts. They can be abstracted definitions of interactions that a user may have with an application, device, or system. Actions can be abstracted definitions of system interactions or unattended calls with an application, device, or system. The keyword creation and implementation module of the platform may allow the user to define the action, and provide one or more construct specific implementations. Moreover, the user may separate actions into various action categories for display and filtering services, and/or place the actions into various visibility levels, such as visible to a user to be shown in the user section, group section, or made visible to the world. Moreover, actions may also be categorized by a line of business, such as pharma, biotech, real estate, restaurant, etc., and may be aggregated to form specific functions. For example, a login function may include a combination of individual actions such as click, enter data, click, etc.

Implementations

Implementations are versioned chunks of software code that provide the construct specific implement of an action. While the user may create implementations in any endpoint language supported by the platform, the number of endpoint languages that can be supported is limitless. As new endpoint languages, application packages, and/or frameworks (i.e., constructs) are developed in the market, new constructs may be added to the platform. This allows code to be generated for each test-script in the user selected construct without a change to the test-script. Thus, users may convert old test-scripts or whole test-suites to new constructs with little or no changes to the test-script or test-suite.

Implementations of actions are versioned, allowing users to select specific, consistent snapshots for repeatable executions. Users may select and generate any implementation version that they choose. Once published, that version may be locked so that it is not changed. Users can rate and comment upon all implementations applying a social aspect as well as version ranking to allow users to pick items that are more suited to their needs. While deprecated implementations may still usable by all current tests, they may be restricted from use in new tests.

An implementation can be made available to the user, to the organization (group permission), or all members during the editing process (world permission). Permissions are set to allow collaboration during the development phase. Once completed, the user can choose to publish their implementation first to their organization then to all members if they choose. Once published to any group, an implementation cannot be changed or unpublished. Any published implementation may be flagged for verification by the platform (i.e., by an administrator of the platform). Verification is completed by way of a code review and may be presented to the user first during the user's test-script creation.

Scripting Module (Test Creation)

The scripting module coordinates closely with the keyword action module. It is used to arrange the actions into test-scripts and/or comprehensive test-suites that can be made to support even the most demanding of client requirements. The scripting module gives the user full control of the scripting process and is designed to maximize the productivity of the user or team of users (i.e., in the collaborative environment).

The scripting module combines actions to form larger, logical definitions of the user, system, or device interactions. The scripting module further allows users to create complex, repeatable interactions regardless of the underlying application, device, or system (i.e., construct). According to certain aspects, these interactions of the platform are created in a drag and drop fashion, and may be included in complex tree structures, wherein certain actions or selections may occur only upon specific outcomes of superseding actions (e.g., conditional constructs).

The scripting module abstracts the underlying endpoint implementations from the actions allowing users to create code chunks that may be exported to any supported construct. The code can generate in the underlying endpoint language separating the underlying implementation from the users experience on the platform.

Reporting integrations are defined at the suite level and are implemented at the test and step level. Users can choose to send steps to differing integration endpoints during execution. Data encryption definitions are per suite by a suite encryption code. Users can update the underlying endpoint with a click. The platform may choose the latest verified of a version of each implementation, or if a verified version is not found it may choose the latest published implementation, or finally the latest available implementation.

A test-suite can reference other test-suites. If the referenced test-suite does not share the same construct, a generator module will attempt to find the latest verified version. If a verified version cannot be located, then the system may search for the next published version. Finally, any available implementation matching that endpoint (i.e., user selected construct) is selected if no published or verified version could be located. A test-script or test-suite can reference one or more endpoint collections defining a set of the reusable endpoints on which to run. A test-script or test-suite can reference one or more object collections defining a set of reusable page objects to use. A test-script or test-suite can reference one or more data sources defining reusable data

Permissions can be set to a test-script or test-suite to make them available to the user, to the organization (group permission), or all members (world permission). Users may have full control over their test-script or test-suite with the ability to enable/disable tests and/or individual steps of a test. Users can set checkpoint actions to assist in troubleshooting as well as conditions and validations.

Endpoints Module (Connect to Devices)

The endpoints module is the platform's device management module and allows the user to connect to their desired destination(s) for testing. Exemplary endpoint types, i.e., destinations, include desktops, devices such as cell phones and tablet computers, virtual devices, terminals, and noop devices. Each endpoint may also be defined by an operating system and version for the operating system, e.g., a desktop may be further defined as running the version 10 of the Windows operating system. Finally, the browser or application under test may be defined, e.g., Internet Explorer, Word, etc. Once the endpoint is fully selected or defined, the endpoint module may validate those selections by attempting to connect to the selected endpoint using the information provided by the user.

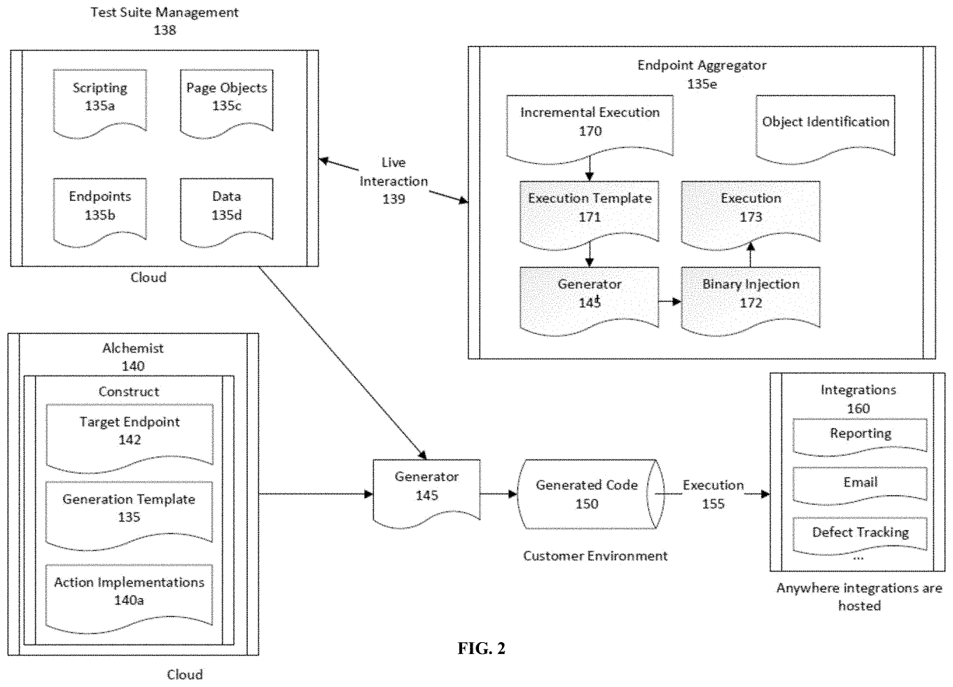

The endpoint module provides compatibility with all major platforms and is not linked to any specific vendor. Accordingly, the module allows the user to work with a variety of systems. The user can connect to other devices across the web (i.e., executor 145 of FIG. 2) as well as use their own computer for testing. The time this saves allows a developer to get started quickly on their project.

Permissions can be set to endpoints, to make them available to the user, to the organization (group permission), or all members (world permission). The endpoints module allows for collections of the environments and endpoints.

Environments define where your endpoints are located. They may be in a cloud vendor, locally connected device farm, local grids, terminal sessions, applications, etc. An endpoint can define multiple environments to run in parallel allowing for a device connected from disparate sources. An endpoint contains a definition for a device, desktop, application, terminal session, etc. These are generic descriptions that the endpoint aggregator or generator interprets to make concrete connections to the underlying endpoints. An endpoint can be validated given that an endpoint aggregator has been created for that endpoint. Testing an endpoint will make the connection and close it, ensuring that it is valid

An environment can be validated in the same way as above testing all endpoints in that environment. Endpoint testing can be performed during execution via a REST or Web Service call to ensure that all devices are available before execution begins. Data encryption definitions are per endpoints by an endpoint's encryption code. Endpoint Aggregators are live execution services allowing for connection, by endpoint type, to endpoints. Generators are endpoint code creators responsible for creating all of the code used to execute a test.

Objects Module (Find Page Objects)

In order to simulate an action like type, click, or verification, the target object of the test application would need to be learned. As used herein the term object (e.g., as in target object, etc.) refers to the various elements that may be found on a web page, and which may include text, graphics, URL's, scripts, and the like. These objects may be learned from an analysis of the code that describes the web page, such as the HTML code. The objects module is configured to identify multiple identification means associated with an object, such as id, name, CSS path (i.e., Cascading Style Sheets path), XPath (XML Path Language).

Prior art methods for defining a “page object” typically required the user to define the id, name, CSS path, XPath, etc. While such methods are possible within the current application(s), the presently disclosed invention allows a user to define page objects using an objects module. This module may contain definitions of page objects, and also allows a user to define items on the computer screen with which they would like to interact. That is, the objects module allows the user to select a previously defined endpoint and navigate to a desired web page on that endpoint. The user may then visually navigate and select a portion of the selected web page, e.g., use the mouse to click on a portion of the selected web page. The objects module will use algorithms to provide all suggested, endpoint specific, identifiers. The identifier list will be ranked based the confidence specified by the object module algorithms. At run time, one or many of the identifiers in the list could be evaluated leading to a much higher level of accurate object identification and more change resilient tests.

The objects module allows the user to save collections of data to be used in their testing, thus allowing for quick and easy data collection. Users can work alone or together on the same collections without any conflicts due to internal locking logic. The objects module provides a robust set of tools at the fingertips of developers that improves efficiency of data retrieval and management.

Various permissions can be set to an objects collection or a page, such as available to a specific user, to the user's organization, or all users of the system. Further, objects may be organized by objects collections and pages.

Users are able to validate an entire page of objects at once. Users are able to selectively import an entire page at once. The objects returned may be obtained using a user-defined list of object extractors and may each run through the same identification rule set used for extracting single objects, thus allowing for the ability to select and modify an imported page before saving it.

Generation Module (Generation of Source Code or Compiled Binary from Test-Script)

Generation combines the abstract action definitions of one or more test cases from one or more test suites into a compilable source package or a compiled binary package for execution. The generation will first select the framework template or construct, containing a guideline of the source framework code that we generate. The Generator will then attempt to bind each abstract action to a concrete, construct compatible implementation. If the user has specified a specific, construct compatible, implementation version, then it is used. Selected a particular version is essential for test reproducibility and repeatable results.

When action implementation is not found or found but not construct compatible, the Generator will select the first Verified implementation consistent with this construct. If the Generator could not find a Verified action implementation, the Generator will locate the first Published action implementation consistent with this construct. If the Generator could not find a Published implementation, then the Generator will locate the first visible action implementation consistent with this construct. Unlike other tools that exist today, the methodology above allows for generating source code and compiling binaries in any construct without changing the test case or suite. The generated source code or compiled binaries are self-contained and no longer rely on the Generator, making a language and tool agnostic tool.

Execution (Testing)

Once code generation is complete, a user or system can execute the code or compiled binaries in any environment. The project can optionally reference the integration allowing reporting and root cause analysis information to flow back to an internal or external integration for review. A project may reference one or more internal or external integrations

AI/Directed Intelligence

The presently disclosed invention may further comprise a module that allows a user to define or tag functions (i.e., combinations of actions and/or page objects) that pertain to a single business process such as, for example, login, order entry, news, menu, etc. Users may populate the tagged functions with an initial set of identification data as well as a set of business methods that could be accessed. Using the login function as an example, a user may specify the business methods “login”, “forgot password,” and “forgot username”. These business methods comprise sets of actions and functions making use of the defined identification data.

Once a collection is defined, it can be added to any test or function needing that functionality regardless of the system or application under test. That is, over time, the system may learn and build on the elements provided in the collection based on potential common functionality within the web-pages and applications used within a business type or model. If an element cannot be properly located using the current identifiers from collection, new identifiers may be added to the overall identification list and ranked according to relevance and use. Further usage of this collection will now be able to reference the additionally added identifiers while locating elements.

Data (Data Driven Testing)

The data module is the data driven testing engine. Users can create, manage, and format data to their liking to best integrate in their project. Data allows for connections to external data sources for quick and easy data management.

Reporting (Reporting and Root Cause Analytics)

The reporting module is the in-depth reporting and root cause analysis tool on the platform. When a test-script or test-suite has executed, the user may receive a report of its successes and failures. When the user sees failures, they can use the reporting module to find out the when, where, why, and how of the failure. Users can view execution times, screenshots of their device status on failures, source dumps, and much more to find root cause. The reporting module may be considered the default reporting engine available for all users. Moreover, according to certain aspects, the reporting module may be used outside of the presently disclosed platform, allowing users with custom test frameworks to integrate with the reporting module.

The reporting module allows for review and verification of test executions, see report of suite executions over time, and drill down to individual test executions. The reporting module may also provide the user with the ability to click on a test step to see data surrounding the test step. Clicking on failed steps may run additional algorithms to provide root cause analysis suggestions.

Analytics (Multi-Suite Organization and Management)

The analytics module provides management a high-level view of the health of the test suite and the application under test.

Versioning (Version Management)

The internal versioning module provides version management by allowing users to take a snapshot of any suite element and save it for later user. While snapshots are read-only, a user may create a new element using that snapshot as a base.

Forum (Platform Updates)

The forum module is a collection of information, alerts, and discussions about the platform. Users can learn about new features and functionality released by anyone in the community as well as updates and release messaging from administrator of the platform. Users can “meet” virtually and share their thoughts regarding the topic, giving the community a voice for any update. Forum entries can be optionally tied to a component and viewable in a context sensitive way during use of the application.

Messaging

The messaging module allows organizations to manage workflows with up to the second updates on what their users are doing. Users can request, track, and manage data in an easy to use section of the platform. Organizations may then stay up to date with the inner workings of their testing team(s).

Exemplary Language Agnostic Quality Assurance Automation Framework.

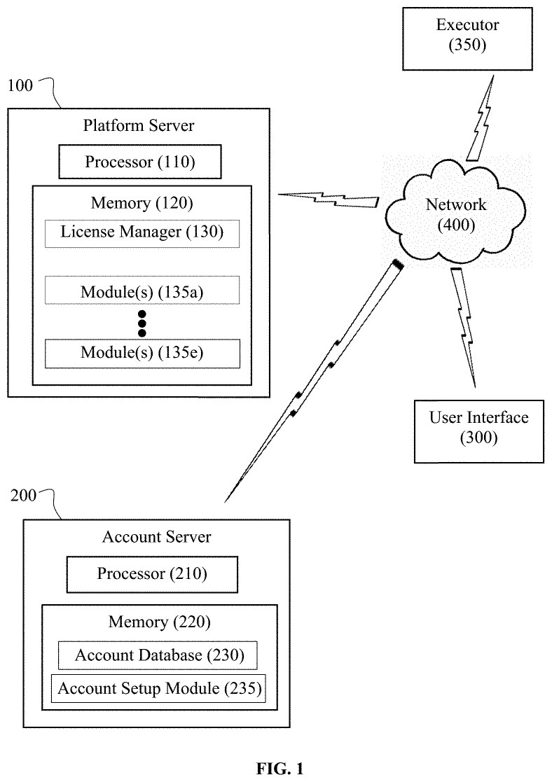

With reference to the figures, FIG. 1 is a diagrammatic diagram of the universal quality assurance automation framework 10. The framework may include a platform server 100, an account server 200, and a user interface 300, all accessible over a network 400. The software application can be presented over any one or more communications network(s) 400 (e.g., public or private) that provide access to the internet. Exemplary networks include at least wide-area-networks (e.g., WANs, cellular data networks, satellite data networks, fiber-optic networks, and/or other information networks capable of enabling communications over large distances), local-area-networks (e.g., LANs, private gaming networks), file sharing networks, social networks, etc.

Multiple users can be connected to the networks via computing devices, such as mobile phones or tablets, desktop or laptop computers, or any other device capable of communication over one or more data networks. The network 400 may have a variety of configurations, and may comprise wired, wireless or a combination of wired and wireless communication pathways. Depending upon the configuration of the network 400, the network may comprise a wide variety of components. For example, the network 400 may include wireless communication relays or transceivers. The network 400 may also include one or more hubs or routers. The network 400 may include dedicated or public lines. For example, one or more portions of the network 400 may include the Internet, phone lines or the like. In general, the network 400 is simply adapted to permit the transmission of data or information between the orchestration server 100, account server 200, and user interface 300.

The platform server 100 can host a website that provides the various components, i.e., modules, of the platform disclosed herein via the internet (400) and/or other computer networks. The platform server 100 can include other devices, servers, mechanisms, etc., that provide functionality (e.g., controls, web pages, applications, etc.) that web users can use to connect to the website and utilize website features (e.g., communications mechanisms, applications, etc.). The platform server 100 can include a memory 120 that may store at least one module 135a, 135b, etc., a license manager 130, and a processor 110 that may execute the computer-executable instructions of the at least one module 135.

The account server 200 can store data on a memory 220 for user accounts in an account database 230, and a processor 210 that may execute computer executable instructions that allow a user to create and manage an account, i.e., an account setup module 235.

The user may interact with the platform server 100 and the account server 200 via a user interface 300 (i.e., a website) over the network 400. The user interface 300 allows the user to create an account and select from a variety of modules to create at least one test-script. The user may then execute the at least one test-script or test-suite on a target system or executor 350.

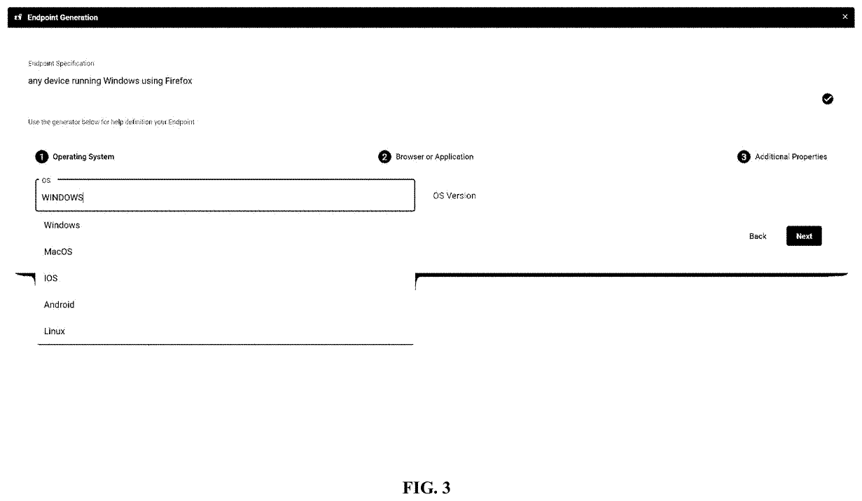

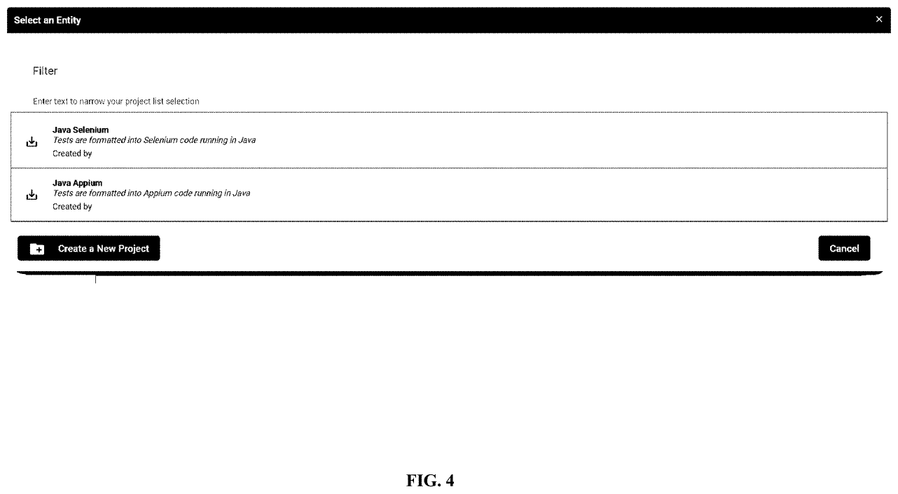

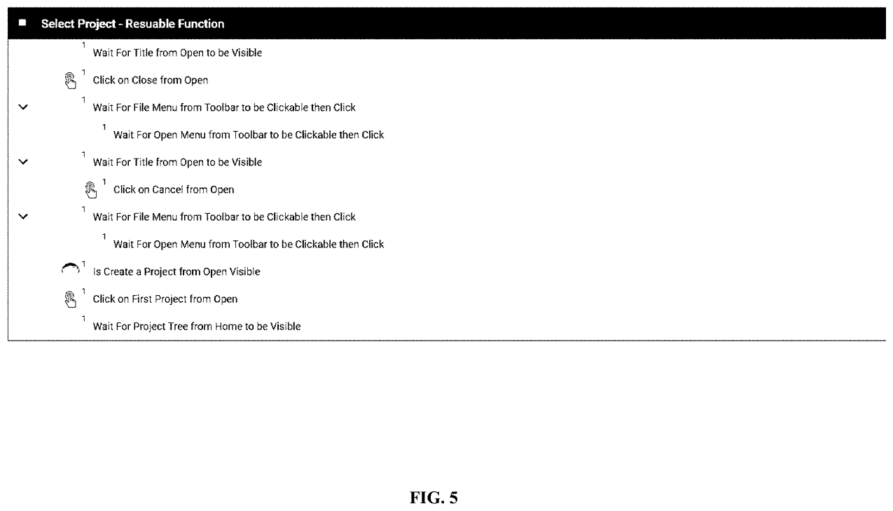

An embodiment of the presently disclosed invention is shown in FIGS. 2-5. The system generally comprises modules that the user may interact with to perform various functions of the platform. For example, the user may use the scripting module 135a to generate a test-script, and the endpoints and construct modules 135b to select a specific endpoint and construct, i.e., language and system framework against which the test-script will be run. An exemplary endpoint selection is shown in FIG. 3, and exemplary construct selection is shown in FIG. 4, and an exemplary script is shown in FIG. 5.

With continued reference to FIG. 2, the user may also interact with the system or application under test 135c to provide definitions of the various page objects which the test-script may target or interact with as well as testing them against a live endpoint, and the data module 135d to provide data that the test-script may need to input during the automated test. The selection of a specific construct using the endpoint module 135b may be validated on the endpoint aggregator module 135e, i.e., the system may check to see that there are construct specific implementations of the various actions used in the test-script. Moreover, the selection of a specific endpoint using the endpoint module 135b may be validated on the endpoint aggregator module 135e, i.e., the system may check to see that the selected endpoint and environment are correctly defined (e.g., network connectable).

Actions and their implementations may be created or edited using the actions definition and implementation module 140a, i.e., shown inside “alchemist” 140 in FIG. 2. Alternatively, the alchemist 140 may provide the action definitions and the various construct specific implementations of those actions selected using the scripting module 135a of the platform 138 to the generator module 145, which uses these implementations to generate the software code or compiled binary 150 for the test-script.

Once a user has created a test-script using the scripting module 135a, selected an endpoint and construct using the endpoint/construct module 135b, provided definitions for any page objects that the test-script may require using the page objects module 135c, and provided any data the test-script may require using the data module 135d, they may generate the test-script 135. The platform references the user designated construct (142) to select the correct implementations (140a) of the various actions in the test-script and generates (145) the construct specific software code or compiled binary for the test-script (150).

The generated code or compiled binary 150 may then be saved, and the user may execute 155 that test-script against the system or application on the user selected construct in the customer environment, bypassing networking and security considerations.

During execution in a customer environment, the selected integrations (160) will be notified indicating execution analytics, success and root cause analysis information.

Each of the aforementioned steps may be repeated to generate test-script code in a different endpoint, i.e., a different construct selection. As such, the alchemist 140 may provide the action definitions and the various construct specific implementations of those actions selected using the platform 138 to the generator module 145, which uses these implementations to generate the software code or compiled binary 150 for the same test-script in the different selected construct. Thus, the user may create a single test-script and use that script to generate construct specific code 150 for a test case.

Moreover, the presently disclosed invention further provides for real-time testing of single or multiple steps in a test-script prior to final generation of source code or compiled binary (i.e., before use of 145 to generate source code or compiled binary 150). As shown in FIG. 2, the presently disclosed systems and methods allow a user to test specific selections of actions, objects, or functions in real-time to determine if they are correctly defined or selected in the test script. As shown, the system provides live interaction 139 in an endpoint aggregator 135e, allowing portions of a test script to be generated and executed. For example, object identification may be tested in real-time to verify that the object has been correctly defined. As example, a user may select a visible graphic on a page, but not have realized a second graphic actually occludes their target graphic on the page.

Actions and functions may also be tested live by generating an execution template 171 for those portions of the test script of interest, wherein a generator 145′ may provide a test code (binary injection 172) that may be executed 173 to verify proper functionality. For example, a test script may include a login function, that has been designed by the user to include a click, data entry, and another click. During live execution the user may find that the login button is slow to load, and thus a wait step may be needed in the test script. Use of the live testing allows the user to save time by quickly and accurately locating and understanding a possible problem with the test script before it is completed.

Implementations of the software application and methods disclosed herein can be described within the context of a device configured to perform various steps, methods, and/or functionality in accordance with aspects of the described subject matter. It is to be appreciated that the software application and methods of the presently disclosed invention can be implemented by one or more computing devices. Implementations of the software application and methods can be described in the context of a “device configured to”, wherein the term configured may be taken to mean that the device can implement computer-executable instructions that are executed to perform various steps, methods, and/or functionality in accordance with aspects of the described subject matter.

In general, a computer system or computing device can include one or more processors and storage devices (e.g., memory and disk drives) as well as various input devices, output devices, communication interfaces, and/or other types of devices. A computer system or computing device can also include a combination of hardware and software. It should be appreciated that various types of computer-readable storage media can be part of a computer system or computing device.

As used herein, the terms “memory”, “computer-readable storage media” and “computer-readable storage medium” do not mean and unequivocally exclude a propagated signal, a modulated data signal, a carrier wave, or any other type of transitory computer-readable medium. In various implementations, the presently disclosed invention may be related to a system comprising a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

The inventive software application disclosed herein can implement and utilize one or more program modules. Generally, program modules include routines, programs, objects, components, data structures, etc., that perform particular tasks or implement particular abstract data types.

The software application disclosed herein can be implemented as a distributed computing system or environment in which components are located on different computing devices that are connected to each other through network (e.g., wired and/or wireless) and/or other forms of direct and/or indirect connections. In such distributed computing systems or environments, tasks can be performed by one or more remote processing devices, or within a cloud of one or more devices, that are linked through one or more communications networks. In a distributed computing environment, program modules can be located in both local and remote computer storage media including media storage devices. Still further, the aforementioned instructions can be implemented, in part or in whole, as hardware logic circuits, which can include a processor.

The software application disclosed herein can be implemented by one or more computing devices such as computers, PCs, server computers configured to provide various types of services and/or data stores in accordance with aspects of the described subject matter. Exemplary sever computers can include, without limitation: web servers, front end servers, application servers, database servers, domain controllers, domain name servers, directory servers, and/or other suitable computers.

Certain examples are provided herein as exemplary of the presently disclosed invention. None of these examples should be considered limiting of the scope or functionality of the presently disclosed inventive methods or systems.

As such, while specific embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

What is claimed is:

1. A method for providing an automated language agnostic quality assurance test, the method comprising computer-implemented instructions that, responsive to a request, execute the following steps:
select a construct against which a test-script is to be executed, wherein the construct comprises an endpoint language, endpoint application package, endpoint framework, or combination thereof;
select one or more actions and one or more objects to include in a test flow to define the test-script, wherein individual actions and objects may be rearranged in the test flow, and wherein the test-script is construct independent; and
generate a source code or compiled binary for the test-script in the selected construct to provide the automated quality assurance test.

2. The method of claim 1, further comprising, before generating the source code or compiled binary for the test-script:
execute at least one of the selected actions and objects of the test flow in real-time.

3. The method of claim 1, further comprising, during selecting the one or more actions and objects to include in the test flow:
execute at least one of the selected actions and objects in the test flow in real-time.

4. The method of claim 1, further comprising, before generating the source code or compiled binary for the test-script:
accept input of attribute values required by the test-script for execution against the selected construct.

5. The method of claim 1, further comprising, before or during selecting the one or more actions:
accept a definition of at least one of the one or more actions and a construct specific implementation thereof.

6. The method of claim 1, further comprising, before or during selecting the one or more objects:
define at least one of the one or more objects by selection of a web-page object or application object.

7. The method of claim 7, wherein selection of the object occurs on a currently rendered web-page, and the computer-implemented instructions parse code describing the web-page to identify the object and associate therewith a respective plurality of identification means.

8. The method of claim 7, wherein the plurality of identification means are associated as an object set for storage in an object repository.

9. The method of claim 1, further comprising:
select an alternate construct against which the test-script is to be executed; and
generate an alternate source code or compiled binary for the test-script in the second construct.

10. The method of claim 1, further comprising, before generating the source code or compiled binary:
validate that construct specific implementations of the actions in the test flow are available.

11. A system for language agnostic automated test generation, the system comprising:
one or more processors; and
a test scripting automation framework stored in a memory for execution by the one or more processors, the framework comprising:
an endpoints module configured to allow selection of an endpoint, wherein the endpoint is any network connected device capable of executing a system or application under test;
a construct module configured to allow selection of a construct against which a test-script is to be executed, wherein the construct comprises a language, application package, framework, or combination thereof,
an objects module configured to allow definition of one or more objects on a system or application under test, wherein selection of the object occurs on a currently rendered web-page, and the objects module parses code describing the web-page to identify the object and associate therewith a respective plurality of identification means,
an actions definition and implementation module configured to allow definition of actions and construct specific implementations thereof,
a scripting module configured to allow generation of the test-script comprising a combination of actions and objects arranged in a test flow, and
a generation module configured to generate construct specific software code for the test-script.

12. The system of claim 11, wherein the framework further comprises:
a live execution module configured to allow live execution of at least a portion of the test-script to validate functionality of actions, objects, or combinations thereof in the test flow.

13. The system of claim 12, wherein the live execution module is further configured to validate the end-point and environment specification.

14. The system of claim 11, wherein the test scripting automation framework stored in the memory is configured to execute a method comprising the steps:
using the construct module, select a construct against which a test-script is to be executed, wherein the construct comprises an endpoint language, endpoint application package, endpoint framework, or combination thereof;
using the scripting module, select one or more actions and one or more objects to include in a test flow to define the test-script, wherein individual actions and objects may be rearranged in the test flow, and wherein the test-script is construct independent; and
using the generation module, generate a source code or compiled binary for the test-script in the selected construct to provide the automated quality assurance test.

15. The system of claim 14, wherein the test scripting automation framework stored in the memory is configured to execute the method further comprising the steps:
using the live execution module during selecting the one or more actions and objects to include in the test flow, execute at least one of the selected actions and objects of the test flow in real-time.

16. The system of claim 14, wherein the test scripting automation framework stored in the memory is configured to execute the method further comprising the steps:
using the scripting module, accept input of attribute values required by the test-script for execution against the selected construct.

17. The system of claim 14, wherein the test scripting automation framework stored in the memory is configured to execute the method further comprising the steps:
using the actions definition and implementation module, accept a definition of at least one of the one or more actions and a construct specific implementation thereof.

18. The system of claim 14, wherein the test scripting automation framework stored in the memory is configured to execute the method further comprising the steps:
using the objects module, define at least one of the one or more objects by selection of a web-page object or application object.

19. The system of claim 18, wherein selection of the web-page object occurs on a currently rendered web-page, and the computer-implemented instructions parse code describing the web-page to identify the object and associate therewith a respective plurality of identification means, wherein the plurality of identification means are associated as an object set for storage in an object repository.

20. The system of claim 14, wherein the test scripting automation framework stored in the memory is configured to execute the method further comprising the steps:
using the construct module, select an alternate construct against which the test-script is to be executed; and
using the generation module, generate an alternate source code or compiled binary for the test-script in the second construct.
